(19) United States
(12) Patent Application Publication
(10) Pub. No.: US 2024/0077603 A1
(43) Pub. Date: Mar. 7, 2024

(54) SENSOR AND SYSTEM FOR MONITORING

(71) Applicant: MariCare Oy, Vantaa (FI)

(72) Inventors: Göran SUNDHOLM, Tuusula (FI); Juha LINDSTRÖM, Espoo (FI); Jarmo KIVINEN, Helsinki (FI); Jari EKBLAD, Espoo (FI)

(73) Assignee: MariCare Oy, Vantaa (FI)

(21) Appl. No.: 18/271,742

(22) PCT Filed: Jan. 12, 2022
(86) PCT No.: PCT/FI2022/050019

§ 371 Date: Jul. 11, 2023

(30) Foreign Application Priority Data
Jan. 15, 2021 (FI) 20215054
Jan. 15, 2021 (FI) 20215056

(51) Int. Cl. G01S 13/72; G01S 7/41; G08B 21/04

(52) U.S. Cl. CPC G01S 13/723; G01S 7/415; G08B 21/043; G08B 21/0461; G08B 21/0476

(57) ABSTRACT

A method, a sensor and a system for observing the presence, location, movement and/or attitude of a person in a monitored area. The sensor comprises means for processing the measurement signal of the sensor, such as measuring electronics, and means for communicating measurement results and/or data relating to the measurement results for further processing. The sensor is a radar-based sensor, such as an as a frequency-modulated continuous-wave MIMO radar-based sensor, configured to detect persons in the monitored area and to measure and detect the location, velocity and/or shape of the monitored person. The sensor comprises means for detecting the orientation of the sensor, such as an acceleration sensor, and the sensor is configured to take the detected orientation of the sensor into account when determining measurement results for the monitored person, e.g. by compensating the measurement results based on the detected orientation.

### FIELD OF THE INVENTION

The invention relates to a method, a sensor and to a system, by means of which persons in a monitored area can be observed, tracked and monitored.

### BACKGROUND OF THE INVENTION

The monitoring of the condition of elderly people in a home environment is indispensable if it is desired to lengthen the possibility of an aging population coping in their home environment. Safety bracelet systems are nowadays widely used for this kind of applications. Their weakness is that the user must wear the bracelet continuously and must be able to press the alarm button in an emergency. There are also bracelets that check the state of health of the user, but they have the same problems as described above, and additionally one of their further problems are false alarms.

There have also been presented solutions in which a film that is of piezoelectric material is installed on the floor, which film registers pressure changes caused by movement on the surface of the floor. Also known in the prior art is the use of sensors to be installed on the floor, or under it, that detect the presence and movements of people without a change in pressure by means of capacitive sensors.

The possibility of using video cameras, movement detectors that are based e.g. on detecting infrared light, or e.g. ultrasound sensors, for monitoring the condition and state of elderly people is also presented in prior art. For example, WO2012164169 document discloses a method and a system that are based on ultrasound technology for tracking objects.

Some prior art solutions are known which use millimeterwave (MMW) radar for tracking persons.

A drawback of observation and monitoring systems known in the art is that they are not able to provide reliable measurement results in different kind of circumstances. In addition to that, observation and monitoring systems of the prior art are complex and expensive to manufacture, install and maintain.

### BRIEF DESCRIPTION OF THE INVENTION

The sensor according to the invention is a sensor configured to measure the state and/or attitude of a person, and the system according to the invention comprises at least one such sensor. In the solution according to the invention the sensors can be installed e.g. on a ceiling, floor or wall. The solution according to the invention can be used e.g. for monitoring the condition and state of elderly people for example in their own homes or in retirement homes.

By using the sensor according to claim 1, the method of claim 10 and the system according to claim 19, the problems of the state of the art can be eliminated. The invention is characterized by what is disclosed in the claims.

In the solution according to the invention a sensor for observing the presence, location, movement and/or attitude of a person in a monitored area comprises means for processing the measurement signal of the sensor, such as measuring electronics, and means for communicating measurement results and/or data relating to the measurement results for further processing. The sensor is a radar-based sensor, such a frequency-modulated continuous-wave MIMO radar-based sensor, configured to detect persons in the monitored area and to measure and detect the location, velocity and/or shape of the monitored person. The sensor can comprise means for detecting the orientation of the sensor, such as an acceleration sensor, and the sensor or the system, e.g. server, is able to take the detected orientation of the sensor into account when determining measurement results for the monitored person, e.g. by compensating the measurement results based on the detected orientation. In one embodiment of the invention the sensor is compensating or taking into account the measurement results based on the location, height and/or detected orientation of the sensor. In one embodiment of the invention the sensor communicates information about the position of the sensor, e.g. location of the sensor in the monitored area, height of the sensor and/or detected orientation of the sensor, and the server takes this into account, e.g. by compensating the measurement results based on the position of the sensor, such as detected orientation of the sensor, height of the sensor and/or location of the sensor in the monitored area.

In one embodiment of the invention the sensor comprises a first operating mode and a second operating mode. In the first operating mode the sensor is configured to track movement of the monitored person and in the second operating mode the sensor is configured to measure and/or further analyze measurements relating to a part of the measured area in which movement of a person was observed in the first operating mode.

In one embodiment of the invention the sensor is configured to essentially continuously use the first operating mode or only to use the first operating mode when the second operating mode is deactivated.

In one embodiment of the invention the sensor is configured to activate the second operating mode based on detecting that the monitored person is not moving, has fallen and/or the speed of the monitored person is slower than a predefined threshold value.

In one embodiment of the invention the sensor is configured to deactivate the second operating mode based on detecting that the monitored person is not determined as fallen, the person is moving and/or the speed of the monitored person is higher than a predefined threshold value.

In one embodiment of the invention in the second operating mode the sensor is configured to analyze the measurement signal in such a way that the phase of the measurement signal is determined in order to observe movement of the object, such as heartbeat and/or breathing.

In one embodiment of the invention in the second operating mode the sensor and/or the measuring electronics of the sensor are configured to analyze the measurement signal from the area and/or certain distance around the area relating to the determined azimuth, elevation and/or distance from the sensor of the person determined in the first operating mode.

In one embodiment of the invention the sensor or system is configured to detect falling and/or sitting of the person by the determined elevation of the person, e.g. such that when the elevation of the person is under certain threshold elevation value, the person can be determined to be fallen.

In one embodiment of the invention the sensor is a radar sensor configured to observe the elevation, azimuth, movement and/or distance of objects.

The invention relates also to a system for observing the presence, location, movement and/or attitude of one or more objects in a monitored area. The system comprises at least one sensor according to invention, wherein the sensor or sensors are fitted in the monitored area, e.g. on a floor, wall and/or ceiling.

In one embodiment of the invention a system for observing the presence, location, movement and/or attitude of one or more objects in a monitored area can be provided which comprises at least one sensor according to solution of the invention.

In one embodiment of the invention the system comprises at least two sensors and the system is configured to detect and measure the persons in the monitored area based on the measurement signal of at least two sensors, which sensors can monitor the same area and/or different part of the monitored area.

In one embodiment of the invention the transmissions of the sensors are synchronized and are carried out in interleaved manner in such a way that the sensors are able to observe the same person and/or the same room.

In one embodiment of the invention the system is further adapted to send a notification of a fall if a person is interpreted as having fallen and/or if the vital functions of the monitored person, such as tracked heartbeat and/or breathing of the monitored person, is not within the predefined limits.

In one embodiment of the invention the notification and/or fall notification is the sending of an alarm or message to person and/or an organization monitoring the health of the object, e.g. as a message to a phone, as an alarm and/or e.g. to a nurse, to relatives or to an emergency center.

One advantage, among others, is that the system is able to reliably observe movement of the person and in addition also health related functions of the person such as heartbeat and breathing with a single integrated sensor.

Also, a system with multiple sensors can be provided so that a bigger area can be monitored. An advantage of one embodiment of the invention, in which multiple radar-based sensors are used in monitoring the persons, the sensors and their operation can be arranged so that they do not cause interference to each other despite the sensors are at least partly operating in same space.

With the above-described solution of the invention, a monitoring system is provided which is known able to provide reliable measurement results in different kind of circumstances and is easy install and maintain.

### BRIEF DESCRIPTION OF THE FIGURES

The invention is illustrated with the following drawings, of which

FIG. 1 presents the components of one example embodiment of the system of the invention, in the area to be monitored,

FIG. 2 presents the operation of one example embodiment of the system of to the invention,

FIG. 3 presents an example embodiment of a sensor according to the solution of the invention, and

FIGS. 4A-B present one embodiment of the invention in which sensors are arranged to a room.

### DETAILED DESCRIPTION OF THE INVENTION

In the solution of the invention the sensors are radar-based sensors which can detect presence and movement of an object. The monitored object can be e.g. an elderly person or some other person benefitting from supervision. The sensor can be installed on the surface, e.g. on a wall, door, floor or ceiling, and/or in the proximity of a surface, such as e.g. floor surfaces, wall surfaces, door surfaces or ceiling surfaces of an apartment and/or of the area to be monitored to which the object has access. The sensor can also be used to observe vital functions of the measured person, such as the breathing and even the heart beating rate of the person. This feature allows to monitor for example a sleeping or fallen person and give an alarm if any unusual phenomena are observed.

In the solution according to the invention the system comprises at least one sensor and can further comprise measuring electronics producing sensor observations by means of the sensors, and a processor configured to process the sensor observations, and/or a central unit comprising a memory, which central unit is e.g. a data processing device. For the purposes of this function the central unit of the system can comprise the necessary software and information about the characteristic properties of the signals being detected. In general, the measuring electronics and/or the central unit can deduce information from a signal received via a sensor. The system can have a central unit, which can manage one or more sensors or sensor groups. In one embodiment of the invention one sensor group comprises e.g. the sensors in the same space, such as in the same room.

An area to be monitored with sensors can be the whole area or only a part of some area. The area to be monitored can comprise e.g. of one or more rooms and certain parts of the area, e.g. fixed installations such as cupboards, can be left outside the area to be monitored.

In the solution according to the invention the sensor detects persons in the monitored area and measures and detects the location, velocity and/or shape of the monitored person. The sensor can comprise means for detecting the orientation of the sensor, such as an acceleration sensor, and the sensor is able to take the detected orientation of the sensor into account when determining measurement results for the monitored person, e.g. by compensating the measurement results based on the detected orientation. In one embodiment of the invention the sensor is configured to observe the object based on signal strength and/or by filtering out probable false measurement results.

The sensor can be installed on the surface, e.g. on a wall, door, floor or ceiling, and/or in the proximity of a surface, such as e.g. floor surfaces, wall surfaces, door surfaces or ceiling surfaces of an apartment and/or of the area to be monitored to which the object has access. In one embodiment of the invention the sensor or sensors are installed on a wall or in a corner of the space to be monitored, typically above the floor-level plane, e.g. at a height of approx. 40-150 cm from the floor. The field of vision of the sensor can be e.g. approx. 90 degrees on the horizontal plane.

The sensor can comprise e.g. a millimeterwave (MMW) radar which can operate for example with the MIMO radar principle. In one example embodiment there can be for example three transmit and four receiver antennas. In that example this forms a virtual antenna of 12 elements. With the sensor of the invention it is possible to observe the elevation, azimuth, movement and distance of objects with good accuracy. E.g. FMCW (frequency modulated continuous wave) technique can be used for the radar.

In one embodiment of the invention the sensor comprises a first operating mode and a second operating mode. In the first operating mode the sensor can be configured to track movement of the monitored person and in the second operating mode the sensor can be configured to measure and/or further analyze measurements relating to a part of the measured area in which movement of a person was observed in the first operating mode.

In one embodiment of the invention the sensor is configured to track the movement of the observed person in the first operating mode by analyzing the detected doppler frequency of the person. In one embodiment of the invention the sensor is configured to track heartbeat and/or breathing of the monitored person in the second operating mode by analyzing the phase of the measurement signal. In one embodiment of the invention wherein the sweep time of the sensor is longer in the second operating mode than in the first operating mode.

In one embodiment of the invention, in the second operating mode tracking of the persons is not performed. In one embodiment of the invention one sensor can use first and second operating mode at the same time, e.g. so that first operating mode is always used and the second operating mode is activated when it's needed and when not needed, the second operating mode is deactivated. In one embodiment of the invention one sensor can use first and second operating mode in an interleaved manner.

The sensor can be configured to activate the second operating mode based on detecting that the monitored person is not moving, has fallen and/or the speed of the monitored person is slower than a predefined threshold value. The sensor can be configured to deactivate the second operating mode based on detecting that the monitored person is not determined as fallen, the person is moving and/or the speed of the monitored person is higher than a predefined threshold value.

In the second operating mode the sensor can be configured to analyze the measurement signal in such a way that the phase of the measurement signal is determined in order to observe movement of the object, such as heartbeat and/or breathing. In one embodiment of the invention in the second operating mode the sensor and/or the measuring electronics of the sensor are configured to analyze the measurement signal from the area and/or certain distance around the area relating to the determined azimuth, elevation and/or distance from the sensor of the person determined in the first operating mode.

In one embodiment the system comprises at least two sensors and is configured to detect and measure the persons in the monitored area based on the measurement signal of at least two sensors, which sensors can monitor the same area and/or different part of the monitored area. For example, the measurement area of the sensors can overlap for example at certain part of the area.

In embodiment of the invention, in an apartment or a nursing home there can be at least one radar in each room. In this case the radars would be interfering with each other if no corrective measures are taken. In one embodiment a division of modes and/or several radars to time slots is presented, so that several radars can be used simultaneously close to each other without causing interference. The transmissions of the sensors can for example be synchronized and carried out in interleaved manner in such a way that the sensors are able to observe the same person and/or the same room.

In one embodiment of the invention different sensors can be in different operating modes, e.g. some sensors have determined a stationary object and have second operating mode as activated while the other sensors are using only the first operating mode to monitor movement of the objects and to search stationary objects.

The system can send a notification of a fall if a person is interpreted as having fallen and/or if the vital functions of the monitored person, such as tracked heartbeat and/or breathing of the monitored person, is not within the predefined limits. In one embodiment a notification and/or a fall notification comprises sending of an alarm or message to a person and/or an organization monitoring the health of the object, e.g. as a message to a phone, as an alarm and/or e.g. to a nurse, to relatives or to an emergency center.

In one embodiment of the invention fixed objects, such as beds or sofas, where the person can lay down, can be determined by the user to the sensor and or a sensor system, and the sensor doesn't determine the person as fallen in the areas of these fixed objects.

In one embodiment of the invention the sensor can distinguish objects from the observed persons by the determined elevation of the observed object, e.g. in such a way that when the elevation of the determined objects is essentially constantly under certain threshold elevation value, the object can be recognized as not being a person.

In some applications it is advantageous to first perform charting of the unchanged area, i.e. to chart the measuring information of the sensors when mainly unmoving and unchanging objects and structures are in place. This type of situation is e.g. in a residential apartment when the furniture is in position but there are no people, pets or robots in the apartment. This charted information can be recorded in the system, e.g. in a memory that is located in the central unit or in a memory means that is in connection via a data network, which memory means can be e.g. in a control center or service center. For this purpose, memory means must be comprised in the arrangement, which memory means can be in the central unit or connected to it via a data network.

According to one embodiment of the invention the system performs charting of the unchanged area continuously or at defined intervals, in which case the system is able to detect e.g. changes in the area caused by new furniture or by changes in the location of furniture. In this way the system is able to adapt gradually to changes occurring in the area to be monitored.

In one embodiment of the invention the sensor or system is configured to detect falling and/or sitting of the person by the determined elevation of the person, e.g. such that when the elevation of the person is under certain threshold elevation value, the person can be determined to be fallen. In one embodiment of the invention the elevation of a person is tracked and filtered with a filter such as a Kalman filter or a low pass filter in order to prevent false alarms due to noisy measurements.

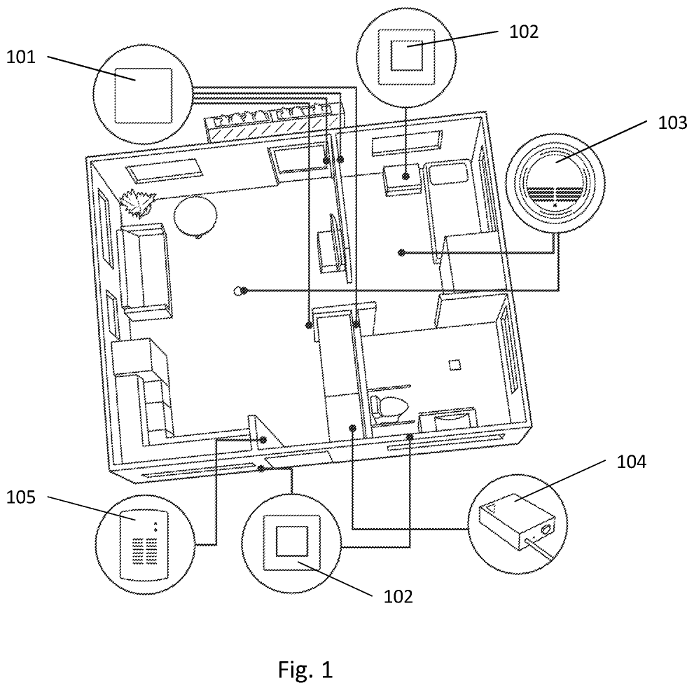

FIG. 1 presents the components of an embodiment of the system according to the invention in the area to be monitored. The sensor 101 or sensors to be used in the invention are disposed in connection with the area to be monitored in such a way that by means of the sensor 101 or sensors the area to be monitored can be monitored. If sensors to be installed on top of a surface, e.g. a wall, floor or ceiling surface, are used they can be fastened to the surface e.g. with double-sided tape or with a sticker strip, in which case they can easily be removed. The sensors 101 can be connected wirelessly or by wireline to a gateway 104, which collects measured values obtained from the sensors 101 or status information formed by the sensors 101, e.g. the objects detected, the state of health of the objects and/or the attitudes of the objects. The gateway 104 sends the information onwards e.g. to a control center or to another body that supervises the area and/or the objects therein. The transfer of information between the system and some recipient can be performed e.g. using a phone connection, a wireline broadband connection or wireless connections. It is advantageous in the data transfer to take into account issues relating to data security and privacy, which many official regulations also address.

In one embodiment of the invention the sensor 101 or sensors comprise their own central unit and the central unit of a sensor is in connection with the gateway 104. In a second embodiment of the invention the central units of the sensor 101 or sensors are integrated into a gateway 104.

It is possible that some of the functions of the central unit or of the gateway 104 are performed elsewhere via a data network connection, e.g. in a central control room or service center.

According to one embodiment of the invention an alarm signal can be given by the system in the space being monitored which lasts a predetermined period of time. This alarm signal can be given e.g. before the sending of an alarm or notification, and it can be given via a light alarm unit and/or a sound alarm unit of the system. The light alarm unit and/or sound alarm units can be in each different part, e.g. room, of the premises. This functionality can also be integrated into the sensors, e.g. into all the sensors or only some of the sensors.

The system according to the invention can also comprise a call pushbutton 102, after the pressing of which the system can form a connection e.g. to nursing personnel, security personnel or it can perform various alarm procedures. The call pushbutton can be wireless and it can be adapted to function without batteries.

The notification procedures and alarm procedures according to the system of the invention can include e.g. the starting of alarm indication signaling (buzzer, light, siren, alarm clock), making contact with an alarm center or service center, a care provider or a relative. In some cases, an alarm can also be given directly to the person being monitored or to the user, e.g. by means of speech synthesis or a speech recording. For performing these tasks, the arrangement can comprise means needed for processing time data, such as e.g. a clock circuit.

The system according to the invention can also comprise fire detectors 103, which can be in connection with another system via a wireline or wireless connection. If the fire detectors 103 warn of a fire, alarm procedures can be performed, e.g. by sending an alarm message to a control center or to the rescue authorities.

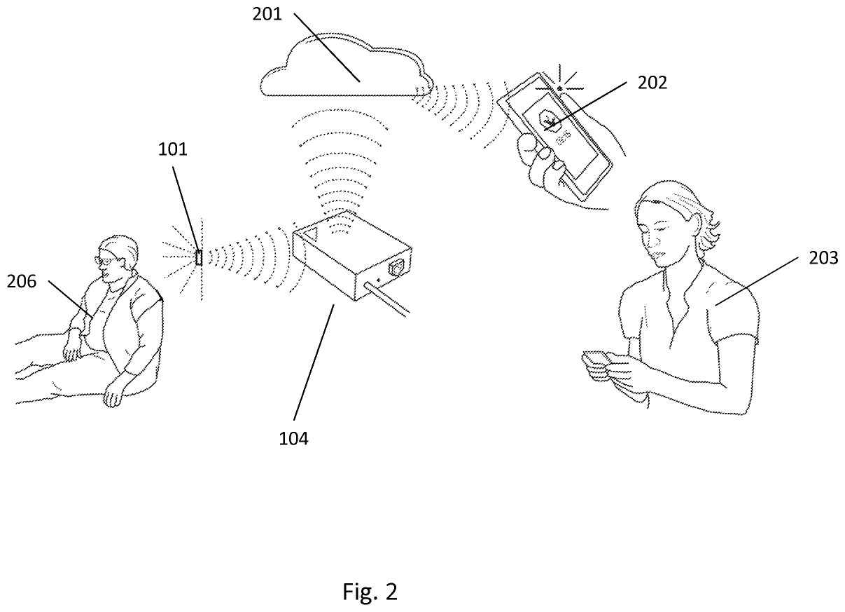

FIG. 2 presents the operation of an embodiment of the system according to the invention, in which the state of health or attitude of a person 206 in the area being monitored is monitored.

If the sensors 101 of the system detect that an object 206 in the area being monitored has fallen and/or the vital functions of the person are not at the acceptable level, the system can send a notification.

In one embodiment of the invention the system examines the information measured by a number of sensors, e.g. by all the sensors in the area being monitored, and a notification of is only sent if no other persons are detected by the sensors.

In the situation in the embodiment presented in FIG. 2, in which the system sends a message e.g. because of the falling of an object or because of determined vital functions of the object, the sensor 101 sends the information about the situation to the gateway 104 of the system and the gateway 104 sends the information and/or an alarm onwards to the server 201 e.g. via an Internet connection or via some other connection. From the server 201 the information and/or alarm is sent to a body monitoring the health of the person, e.g. as a message to a phone 202, as an alarm and/or e.g. to a nurse 203, to relatives or to an emergency center. In this way e.g. information about the falling or health of the person reaches the necessary people or organizations and the person who fell receives help as quickly as possible. In one embodiment of the invention the system can send information directly from the gateway 104 to an organization or a person monitoring the health of the monitored person.

The processor, central unit and/or measuring electronics used in the solution of the invention can be integrated into the sensors or they can be disposed separately or in separate units. In an embodiment of the invention, with a software executed by the processor the sensor or system can interpret the movements observed with at least one sensor and can give an alarm if the alarm conditions defined for the program are fulfilled.

In one embodiment of the invention only some of the sensors of the area to be monitored have the functionality enabling the issuing of an alarm signal as described above. For example, the sensors in only some rooms, such as in the living room, can be provided with this functionality and the sensors in other rooms send a notification onwards immediately after a fall is detected and/or measurement results of a measured person are not at acceptable and/or in predefined range. In one embodiment of the invention only some of the sensors in one space, such as in a room, comprise the functionality enabling the issuing of an alarm signal as described above.

The system can also comprise a control center and the predetermined information concerning the presence, location, movement and/or attitude of the object can be sent to the control center. The alarm terms used by the system can be changed, e.g. on the basis of presence information, which can be e.g. received from an RFID reader. A notification can be sent or an alarm can be given e.g. to an external alarm system or wirelessly to a central server of the system, from which server the alarm is directed onwards.

The system can also have memory means, in which the system is adapted to record a measurement signal, or information derived from it, for observing the chronological dependency of the area being monitored and the behavior of objects. By means of this the system can give an alarm e.g. if a person being monitored has not got out of bed or visited the kitchen for a certain time, or if the person has gone to the toilet too often or if the vital functions of the observed person, such as breathing or heartbeat, have changed during time. The memory means also enables learning of a more common daily rhythm and the detection of aberrations occurring in it.

In the following one example embodiment is described. In this example embodiment, first operating mode of the sensor is used to track the presence and movements of people, e.g. in a single room. In this embodiment the tracking is carried out with the measured point cloud data. Doppler range needed is given by

$${f}_{Dmax} = \frac{2 v}{λ}$$

In one example, if the person is moving with a speed of 1 m/s, the needed Doppler range is +−40 Hz and the maximum measurement interval is 25 ms at 60 GHz frequency. Inbreathing lasts about 2 seconds. If the corresponding movement is 5 cm, the Doppler range needed is +−1 Hz and the sweeping time is one second.

When the system observed that the person has stopped, it can activate the second operating mode, in which it is able to track vital functions of the person, such as heartbeat and/or breathing.

After the vital functions of the object are determined, the system can deactivate the second operating mode. In one example embodiment, the system can determine vital function of the same person periodically, e.g. as long as the person stays stationary. If the system observes stationary objects, it starts to determine vital functions of these objects by using the second operating mode.

In one example embodiment of the invention operation in the second operating mode can be implemented for example so that when the stationary object has been detected, point cloud data around an area of the detected object is saved and analyzed. The saved packages can be generated periodically, e.g. every 600 ms. In one embodiment of the invention the data can be transferred to central control units for analysis. With the analysis of the signal, i.e. the point cloud data, information about small movements of the object can be observed and thus the system is able to determine e.g. breathing activity and/or heartbeat of the person.

In one embodiment of the invention the sweep time of the sensor is longer in the second operating mode and because of this better signal to noise ratio can be achieved. Also, more TX-antennas can be utilized because there is more time available for measurement. This way the angle resolution can be improved. For improving the distance resolution, the frequency sweep range can be increased.

The doppler frequency can be determined e.g. with Fast Fourier Transformation (FFT). The vital function activity, e.g. heartbeat and breathing activity, can be determined based on the determined doppler frequency. In one embodiment of the invention there are more TX antennas used in the second operating mode to increase the spatial resolution. Signal processing can be done for a smaller area because the measured person is not moving.

In one embodiment of the invention the sensor can comprise radio-based identification means for identifying a person. The radio-based identification means can be for example Bluetooth, Bluetooth low energy (BLE) or Zigbee based means. In this embodiment the system can recognize the object and a radio-based device carried by the object, such as a bracelet, a watch, a mobile device, a tag, and the measurement results can be linked to the specific recognized person. This way the systems is able to know who is present in the measured area and to whom the measurement results relate.

In one embodiment of the invention the radio-based identification means can comprise an antenna array that makes it possible to more accurately associate the identification devices to their carriers when there are more than one person and device present.

In one embodiment of the invention the alarms can be automatically disabled if the identification means detect a certain person such as a nurse in the monitored area.

In one embodiment of the invention the alarm conditions of the system can include the identity of the person. For example, an alarm can be triggered when an unauthorized person enters certain location.

In one embodiment of the invention the radio-based identification means, for example Bluetooth, Bluetooth low energy (BLE) or Zigbee based means, can be used in locating a person or assist in locating the person. The sensor can include several antennas for radio-based identification means, e.g. Bluetooth, BLE or Zigbee antennas to enable direction finding techniques, for example Zigbee, Bluetooth or Bluetooth low energy (BLE) direction finding techniques, e.g. according to Bluetooth 5.1 specification. In one embodiment of the invention, if the radar of the sensor detects movement but the radio-based identification means do not detect a remotely readable tag or device, such as a Bluetooth, BLE or Zigbee tag or device, then the person detected by the radar can be considered a visitor. If, on the other hand, the radar detects a remotely readable tag or device, such as a Bluetooth, BLE or Zigbee tag or device, then the detected person can be identified, and actions can be taken based on the identified person. In one example embodiment, when a resident is in a room and there is also an assisting person, the status of the person or the room can be set in the system to “an assisting person present in the room”. In the same way, an alarm made by a resident can also be acknowledged as the system recognizes that a person, who is not a resident in the room, enters the room. In this case the alarm can be acknowledged automatically. In one embodiment an alarm is not acknowledged automatically but requires an active identifiable event, e.g. from the user device.

In one embodiment of the invention identification of the detected person can be done with other means, for example with surveillance cameras, e.g. arranged to corridors. In this case the radar-based sensor detects that someone is entering the room and the system can check information from the surveillance cameras, e.g. from a certain point in time from the surveillance recording, in which a person can be seen to enter the room. In one embodiment this recording could be linked to the room as an entry event and the entrant could be identified later, if necessary, by looking at the recording. In that case the identification can be automatic but automatic identification doesn't have to be implemented if not preferred. If automatic identification from the video is used, it can be implemented e.g. based on facial recognition techniques. In one embodiment, if user can be identified in other ways, facial recognition or video-based recognition is not used. In one embodiment video-based identification is only used if person can't be identified in any other way.

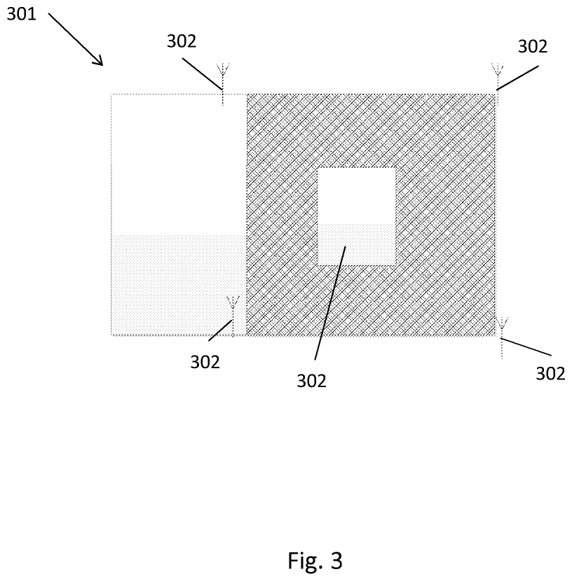

In one embodiment of the invention in which the radio-based identification means are used, the necessary electronics and antennas can be integrated to the sensor. An example embodiment is presented in FIG. 3 in which a Bluetooth antenna array is integrated to the sensor 301. The Bluetooth antenna array of FIG. 3 comprises four antennas 302 and required electronics that controls the operation of the identification means and the antennas. The antenna array can be utilized in measuring and detecting Bluetooth devices and tags and e.g. to locate a person carrying a Bluetooth device such as a bracelet, using Bluetooth 5.1 direction finding technique. In one embodiment the data measured with Bluetooth antenna array is combined, e.g. by the sensor, to the data measured by the radar to increase the location and positioning accuracy of the radar sensor. The antenna or antenna array of the radar 303 arranged in this embodiment in the center of the sensor and inside the area formed by the four Bluetooth antennas 302.

In one embodiment of the invention, the sensor according to the invention can be used e.g. in hospital rooms or in rooms where the people are sleeping and their monitoring is needed. In this embodiment the sensor can be arranged so that it is able to measure and sense a person who is present in the bed. The sensors can be arranged to the room or in connection with the room so that the measurement area of one sensor covers at least part of one bed. In one embodiment of the invention the sensors are arranged to the ceiling of the room, e.g. above each bed, for example one sensor above each bed. In one embodiment of the invention the sensors are arranged to the wall of the room, e.g. beside each bed, for example one sensor beside each bed. With these embodiments the sensor is able to measure and/or sense presence of the person in a bed but also vital functions, such as movement, heartbeat and breathing, of the person. One of the advantages of these embodiments is that a sleeping person can be monitored without disturbing him which is not possible for example with wired sensors. Also monitoring of people who should be sleeping is easy for the personnel and nurses e.g. in hospital environment with this embodiment. With these embodiments the sensor does not have to comprise means for detecting the orientation of the sensor.

In one embodiment of the invention at least one additional sensor according to the invention can be arranged to the monitored room or area where people are sleeping. This additional sensor is able to sense and measure persons that have left their bed. In this case the measurement area of the additional sensor can be bigger than the measurement area of the sensors monitoring beds. The measurement area can cover essentially the whole room, e.g. with a single or multiple additional sensors. Also this additional sensor can be arranged to the room or in connection with the room so that the measurement area of the sensor or sensors cover the room and especially areas outside the beds. In one embodiment the additional sensor can be arranged to the ceiling, wall and/or corner of the room. With this embodiment the room can be better monitored by the personnel and e.g. an alarm can be given if people are leaving their beds and/or disturbing other people who are trying to sleep. These additional sensors also make it possible to monitor people who have left their bed, and e.g. to generate an alarm if a person falls and/or or if the determined vital functions are not at the predefined and/or acceptable level. With these embodiments the additional sensor does not have to comprise means for detecting the orientation of the sensor.

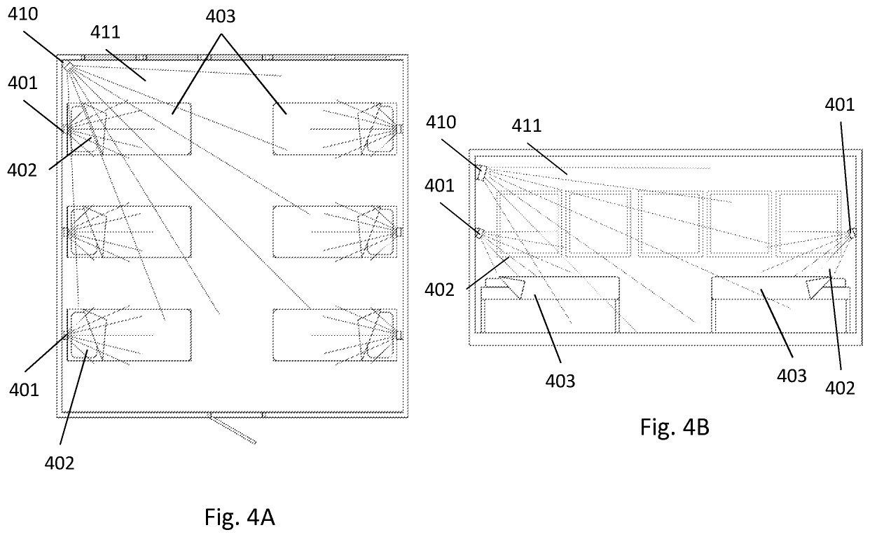

FIGS. 4A and 4B present as an example how this embodiment can be implemented in a room, e.g. a hospital room. FIG. 4A presents a room from above and FIG. 4B the same room as a side view. In this example embodiment beds 403 are arranged to the room. Sensors 401 are arranged to the room so that the measurement area 402 of one sensor 401 covers at least part of one bed 403. In one embodiment of the invention the sensors 401 are arranged to the wall of the room, e.g. beside each bed 403, for example one sensor beside each bed as presented in FIGS. 4A and 4B. An additional sensor 410 is also arranged to the monitored room or area where people are sleeping. This additional sensor 410 is able to sense and measure persons that have left their bed 403. In this case the measurement area 411 of the additional sensor 410 is bigger that the measurement area of the sensors 401 monitoring the beds 403. The measurement area 411 of the additional sensor 410 can cover essentially the whole room. The additional sensor 411 can be arranged to the ceiling, wall and/or corner of the room.

One embodiment of the invention relates to a sensor arrangement for observing the presence, location, movement and/or attitude of a person in monitored area, the sensor arrangement comprising an infrared based sensor, such as a PIR-sensor, and a radar-based sensor. The sensor arrangement further comprises means for processing the measurement signals of the sensors, such as measuring electronics. The infrared based sensor is configured to measure the monitored area and detect movement of the person in the monitored area. The radar-based sensor is configured to measure the monitored area and detect movement of the person in the monitored area. The sensor arrangement is configured to use the infrared based sensor for observing movement in the monitored area and to enable the radar-based sensor to measure when the infrared based sensor is not able to observe movement in the monitored area and/or the observed movement by the infrared based sensor in the monitored area is below a predefined threshold level. The radar-based sensor can be disabled when it's not needed, e.g. when it has not detected any movement or when accurate measurement results are not needed. Then the monitoring of the area can be continued with the infrared based sensor.

In one embodiment of the invention the sensor arrangement is configured to disable the radar-based sensor when the infrared based sensor is able to observe movement in the monitored area and/or the observed movement by the infrared based sensor in the monitored area is above the predefined threshold level.

In one embodiment of the invention the measurement area of infrared based sensor is arranged and/or limited so that the infrared based sensor cannot observe movement below certain height, e.g. on the floor level.

In one embodiment of the invention the sensor arrangement comprises a battery configured to provide energy for the sensor arrangement. In one embodiment of the invention the sensor arrangement comprises a mains electricity power supply configured to provide energy for the sensor arrangement and/or the battery.

In one embodiment of the invention the sensor arrangement structure comprises an attachment structure in which the sensor arrangement can be placed, wherein the attachment structure is fixable to a wall or ceiling. In one embodiment of the invention the sensor arrangement is removable from the attachment means without any tools e.g. for charging the battery of the sensor arrangement. The sensor arrangement or attachment structure for the sensor arrangement can be arranged to a wall, e.g. at the height or higher than the height of 1.5 m from the floor level.

In one embodiment of the invention the radar-based sensor is configured to determine objects and their azimuth, elevation and/or distance from the sensor based on the measurement signal.

In one embodiment of the invention the sensor arrangement is configured to analyze the measurement signal by at least filtering the measurement signal such a way that the phase of the measurement signal is determined in order to observe movement of the object, such as heartbeat and/or breathing.

In one embodiment of the invention the sensor arrangement is configured to detect falling and/or sitting of the person by the determined elevation of the person, e.g. such that when the elevation of the person is under certain threshold elevation value, the person can be determined to be fallen.

In one embodiment of the invention the radar-based sensor is a radar sensor configured to observe the elevation, azimuth, movement and/or distance of objects, e.g. with continuous-wave radar technique, such as a frequency-modulated continuous-wave (FMCW).

In one embodiment of the invention the sensor arrangement comprises means to detect the attitude of the sensor, such as an acceleration sensor, and the sensor is configured to take attitude of the sensor into account when determining azimuth, elevation and/or distance from the sensor of the person.

One embodiment of the invention relates also to method for observing the presence, location, movement and/or attitude of a person in monitored area with a sensor arrangement, the sensor arrangement comprising an infrared based sensor, such as a PIR-sensor, and a radar-based sensor, the sensor arrangement further comprising means for processing the measurement signals of the sensors, such as measuring electronics. The infrared based sensor measures the monitored area and detects movement of the person in the monitored area. The radar-based sensor measures the monitored area and detects movement of the person in the monitored area. The sensor arrangement uses the infrared based sensor for observing movement in the monitored area and enables the radar-based sensor to measure when the infrared based sensor is not able to observe movement in the monitored area and/or the observed movement by the infrared based sensor in the monitored area is below a predefined threshold level.

One embodiment of the invention relates also to a system for observing the presence, location, movement and/or attitude of one or more objects to be monitored in the area to be monitored. The system comprises at least one sensor arrangement according to the invention, wherein the sensor arrangement or sensor arrangements are fitted in the monitored area, e.g. on a floor, wall and/or ceiling.

In one embodiment of the invention the system comprises at least two said sensor arrangements of the invention and the system is configured to detect and measure the persons in the monitored area based on the measurement signal of at least two sensor arrangements, which sensor arrangements can monitor the same area and/or different area.

In one embodiment of the invention the system is further adapted to send a notification of a fall if a person is interpreted as having fallen and/or if the vital functions of the monitored person, such as tracked heartbeat and/or breathing of the monitored person, is not within the predefined limits.

In one embodiment of the invention the notification and/or fall notification is the sending of an alarm or message to person and/or an organization monitoring the health of the object, e.g. as a message to a phone, as an alarm and/or e.g. to a nurse, to relatives or to an emergency center.

In one embodiment of the invention the system is adapted to send information derived from the object onwards using a wireline or wireless communications means.

In one embodiment of the invention the sensor, sensor arrangement and/or sensor system comprises at least one light source, e.g. a LED light source, wherein the sensor arrangement is configured to activate the light source when the sensor observes a standing person, e.g. at certain time of the day and/or when the light level in the measured area is low. The sensor arrangement can comprise means to measure light level in the measured area.

Usually radar based sensors consume more energy that infrared based sensors. The solution of the embodiment with a sensor arrangement comprising both the radar-based sensors and infrared based sensor is able to lower the energy consumption of the monitoring solution and thus make it possible that the sensor arrangement can be powered e.g. by battery power. In the solution of the invention the sensor arrangement uses the infrared based sensor for observing movement in the monitored area and enables the radar-based sensor to measure only when it's needed, e.g. when more accurate or detailed measurements are needed. This can be implemented e.g. with the measurement area of infrared based sensor being arranged and/or limited so that the infrared based sensor cannot observe movement below certain height, e.g. on the floor level. In this case the infrared based sensor is not able to observe movement in the monitored area and/or the observed movement by the infrared based sensor in the monitored area is below a predefined threshold level and more accurate measurements can be carried out with radar-based sensor for example for a fallen person. In this situation radar-based sensor is used and when accurate measurements are not needed the radar-based sensor can be disabled and the area can be monitored with the infrared based sensor.

It is obvious to the person skilled in the art that the different embodiments of the invention are not limited solely to the examples described above, and that they may therefore be varied within the scope of the claims presented below. The characteristic features possibly presented in the description in conjunction with other characteristic features can also, if necessary, be used separately to each other.

1. A sensor for observing the presence, location, movement and/or attitude of a person in a monitored area, wherein
the sensor comprises means for processing the measurement signal of the sensor, such as measuring electronics, and means for communicating measurement results and/or data relating to the measurement results for further processing,
wherein the sensor is a radar-based sensor, such as a frequency-modulated continuous-wave MIMO radar-based sensor, configured to detect persons in the monitored area and to measure and detect the location, velocity and/or shape of the monitored person, and
wherein the sensor comprises means for detecting the orientation of the sensor, such as an acceleration sensor, and the sensor and/or a system, e.g. server, is configured to take the detected orientation of the sensor into account when determining measurement results for the monitored person, e.g. by compensating or taking into account the measurement results based on the detected orientation and/or by communicating the detected orientation.

2. A sensor according to claim 1, wherein the sensor comprises a first operating mode and a second operating mode,
wherein in the first operating mode the sensor is configured to track movement of the monitored person, and
in the second operating mode the sensor is configured to measure and/or further analyze measurements relating to a part of the measured area in which movement of a person was observed in the first operating mode.

3. A sensor according to claim 2, wherein the sensor is configured to essentially continuously use the first operating mode or only to use the first operating mode when the second operating mode is deactivated.

4. A sensor according to claim 2, wherein the sensor is configured to activate the second operating mode based on detecting that the monitored person is not moving, has fallen and/or the speed of the monitored person is slower than a predefined threshold value.

5. A sensor according to claim 1, wherein the sensor is configured to deactivate the second operating mode based on detecting that the monitored person is not determined as fallen, the person is moving and/or the speed of the monitored person is higher than a predefined threshold value.

6. A sensor according to claim 1, wherein in the second operating mode the sensor is configured to analyze the measurement signal in such a way that the phase of the measurement signal is determined in order to observe movement of the object, such as heartbeat and/or breathing.

7. A sensor according to claim 1, wherein in the second operating mode the sensor and/or the measuring electronics of the sensor are configured to analyze the measurement signal from the area and/or certain distance around the area relating to the determined azimuth, elevation and/or distance from the sensor of the person determined in the first operating mode.

8. A sensor according to claim 1, wherein the sensor is configured to detect falling and/or sitting of the person by the determined elevation of the person, e.g. such that when the elevation of the person is under certain threshold elevation value, the person can be determined to be fallen.

9. A sensor according to claim 1, wherein the sensor is a radar sensor configured to observe the elevation, azimuth, movement and/or distance of objects, e.g. with continuous-wave radar technique, such as a frequency-modulated continuous-wave (FMCW).

10. A sensor according to claim 1, wherein the sensor is arranged beside or above a bed so that the measurement area of the sensor covers at least part of the bed and/or a person lying on the bed, and the sensor is arranged to measure a person on the bed.

11. A method for observing the presence, location, movement and/or attitude of a person in a monitored area, wherein
a sensor is used in the method which comprises means for processing the measurement signal of the sensor, such as measuring electronics, and means for communicating measurement results and/or data relating to the measurement results for further processing, wherein the sensor is a radar-based sensor, such as a frequency-modulated continuous-wave MIMO radar-based sensor, and
in the method the sensor detects persons in the monitored area and measures and detects the location, velocity and/or shape of the monitored person, and
wherein the sensor comprises means for detecting the orientation of the sensor, such as an acceleration sensor, and the sensor and/or the system, e.g. server, takes the detected orientation of the sensor into account when determining measurement results for the monitored person, e.g. by compensating or taking into account the measurement results based on the detected orientation and/or by communicating the detected orientation.

12. A method according to claim 11, wherein the method comprises a first operating mode and a second operating mode for the sensor,
wherein in the first operating mode the sensor tracks movement of the monitored person, and
in the second operating mode the sensor measures and/or further analyzes measurements relating to a part of the measured area in which movement of a person was observed in the first operating mode.

13. A method according to claim 12, wherein the sensor uses essentially continuously the first operating mode or only uses the first operating mode when the second operating mode is deactivated.

14. A method according to claim 12, wherein the sensor activates the second operating mode based on detecting that the monitored person is not moving, has fallen and/or the speed of the monitored person is slower than a predefined threshold value.

15. A method according to claim 11, wherein the sensor deactivates the second operating mode based on detecting that the monitored person is not determined as fallen, the person is moving and/or the speed of the monitored person is higher than a predefined threshold value.

16. A method according to claim 11, wherein in the second operating mode the sensor analyzes the measurement signal in such a way that the phase of the measurement signal is determined in order to observe movement of the object, such as heartbeat and/or breathing.

17. A method according to claim 11, wherein in the second operating mode the sensor and/or the measuring electronics of the sensor analyze the measurement signal from the area and/or certain distance around the area relating to the determined azimuth, elevation and/or distance from the sensor of the person determined in the first operating mode.

18. A method according to claim 11, wherein the sensor detects falling and/or sitting of the person by the determined elevation of the person, e.g. such that when the elevation of the person is under certain threshold elevation value, the person can be determined to be fallen.

19. A method according to claim 11, wherein the sensor is a doppler radar sensor, such as a mmWave doppler radar sensor, configured to observe the elevation, azimuth, movement and/or distance of objects, e.g. with continuous-wave radar technique, such as a frequency-modulated continuous-wave (FMCW).

20. A system for observing the presence, location, movement and/or attitude of one or more objects in a monitored area,
wherein the system comprises at least one sensor according to claim 1,
wherein the sensor or sensors are fitted in the monitored area, e.g. on a floor, wall and/or ceiling.

21. A system according to claim 20, wherein the system comprises at least two sensors and the system is configured to detect and measure the persons in the monitored area based on the measurement signal of at least two sensors, which sensors can monitor the same area and/or different part of the monitored area.

22. A system according to claim 21, wherein the transmissions of the sensors are synchronized and are carried out in interleaved manner in such a way that the sensors are able to observe the same person and/or the same room.

23. A system according to claim 20, wherein the system is further adapted to send a notification of a fall if a person is interpreted as having fallen and/or if the vital functions of the monitored person, such as tracked heartbeat and/or breathing of the monitored person, is not within the predefined limits.

24. A system according to claim 20, wherein the notification and/or fall notification is the sending of an alarm or message to person and/or an organization monitoring the health of the object, e.g. as a message to a phone, as an alarm and/or e.g. to a nurse, to relatives or to an emergency center.

25. A system according to claim 20, wherein the sensor or the system comprises or is connected to radio-based identification means, for example Bluetooth, Bluetooth low energy (BLE) or Zigbee based means, and the sensor or system is configured to use the radio-based identification means to identify and/or locate a person or a device carried by the person or assist in identifying and/or locating the person.

26. A system according to claim 20, wherein the sensor or the system comprises or is connected to camera-based identification means, for example a surveillance camera, and the sensor or the system is configured to use the camera-based identification means in identifying a person.

27. A system according to claim 20, wherein the sensor is arranged beside or above a bed so that the measurement area of the sensor covers at least part of the bed and/or a person lying on the bed, and the sensor is arranged to measure a person on the bed.

28. A system according to claim 27, wherein the system comprises at least one additional sensor, which is arranged to a room in which beds are monitored with sensors and the measurement area of the additional sensor or additional sensors is arranged such that it covers essentially the whole room and/or the additional sensor or sensors are arranged to measure and/or sense persons at least outside bed areas.
